(19) United States
(12) Patent Application Publication
(10) Pub. No.: US 2009/0078477 A1
(43) Pub. Date: Mar. 26, 2009

(54) ELECTRONIC DEVICE WITH SOUND PROMPT FUNCTION

(75) Inventors: JUI-LIN KE, Tu-Cheng (TW); HAN-CHE WANG, Tu-Cheng (TW); CHUAN-HONG WANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/180,554

(22) Filed: Jul. 27, 2008

(30) Foreign Application Priority Data
Sep. 21, 2007 (CN) 200710077341.9

(51) Int. Cl. G06F 3/01

(52) U.S. Cl. 178/18.07

(57) ABSTRACT

An electronic device including touch inductive apparatus having sound prompt function is provided, the electronic device comprises at least one touch inductive apparatus for sensing a finger touch thereto and accordingly changing an electrical character thereof; a memory configured for storing at least one prompt signal corresponding to at least one predetermined frequency interval; a frequency converter configured for outputting a frequency signal in accordance with the electrical character of the at least one touch inductive apparatus; a frequency scanning unit configured for scanning the frequency signal and outputting a frequency value accordingly; a processor configured for selecting the prompt signal if the frequency value is included in the at least one predetermined frequency interval; an audio processing unit configured for processing the prompt signal; and a speaker configured for outputting an audible sound of the prompt signal.

### BACKGROUND OF THE INVENTION

1. Field of the Invention

The present invention relates to electronic devices including touch inductive apparatuses, and more particularly to an electronic device capable of giving out a sound prompt when sensing finger touching its touch inductive apparatus, whereby to simulate operation noise of mechanical keys.

2. General Background

Conventional electronic devices often include mechanical keys and buttons, which give out a response prompt when the keys and buttons are pressed to operate the electronic device to perform a corresponding function.

Recently, more and more touch inductive apparatuses are applied to replace the mechanical keys and/or buttons of electronic devices so as to reduce product volume. However, the touch inductive panels cannot give out a sound prompt so as to simulate the operation noise of the mechanical keys when fingers are placed on the touch inductive apparatus to operate the electronic device. Therefore, it is necessary to provide an electronic device capable of giving out a sound prompt when sensing finger touching the touch inductive apparatus so as to simulate operation noise of mechanical keys.

### SUMMARY OF INVENTION

An electronic device including touch inductive apparatus having sound prompt function is provided, the electronic device comprises at least one touch inductive apparatus for sensing a finger touch thereto and accordingly changing an electrical character thereof; a memory configured for storing at least one prompt signal corresponding to at least one predetermined frequency interval; a frequency converter configured for outputting a frequency signal in accordance with the electrical character of the at least one touch inductive apparatus; a frequency scanning unit configured for scanning the frequency signal and outputting a frequency value accordingly; a processor configured for selecting the prompt signal if the frequency value is included in the at least one predetermined frequency interval; an audio processing unit configured for processing the prompt signal; and a speaker configured for outputting an audible sound of the prompt signal.

### BRIEF DESCRIPTION OF DRAWINGS

FIG. 1 is a block diagram of an electronic device including a touch inductive apparatus having sound prompt in accordance with an exemplary embodiment of the present invention.

FIG. 2 is a block diagram of an exemplary embodiment of the electronic device of FIG. 1, in the exemplary embodiment, the electronic device includes a capacitance-type touch inductive apparatus and a capacitance-frequency converter.

FIG. 3 is a line chart showing a relationship of a frequency signal outputted by the capacitance-frequency converter and capacitance of the capacitance-type touch inductive apparatus of FIG. 2.

FIG. 4 is an exemplary look-up table recording a relationship of a plurality of frequency intervals and a plurality of prompt signals.

### DETAILED DESCRIPTION OF THE EMBODIMENTS

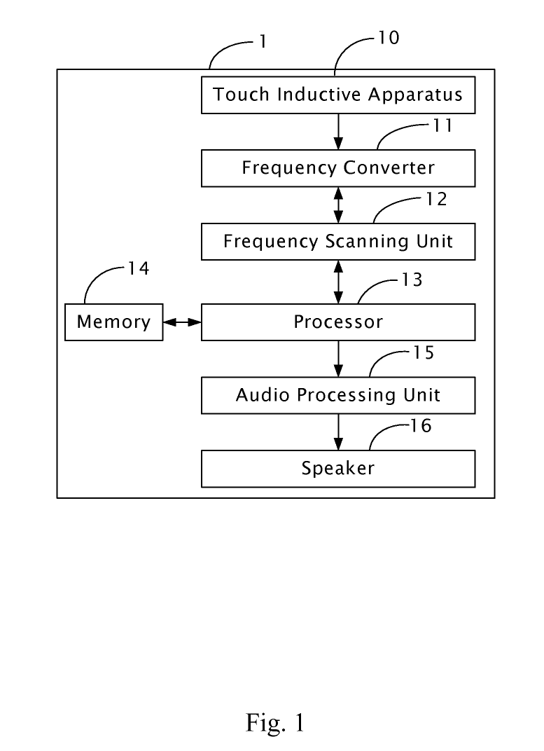

FIG. 1 is a block diagram of an electronic device including a touch inductive apparatus having sound prompt (hereinafter “the electronic device 1”) in accordance with an exemplary embodiment of the present invention. The electronic device 1 includes at least one touch inductive apparatus 10 for sensing a touch of fingers by changing its electrical character during the touch. For example, if the touch inductive apparatus 10 is of capacitance-type or resistance-type, the electrical character of the touch inductive apparatus 10, i.e., a capacitance value or a resistance value, is changed during the touch. A frequency converter 11 is configured for outputting a frequency signal in accordance with the electrical character of the touch inductive apparatus 10. A frequency scanning unit 12 is configured for scanning the frequency signal and outputting a frequency value. A processor 13 is configured for selecting a prompt signal corresponding to the frequency value according to a look-up table stored in a memory 14. The look-up table records a plurality of frequency intervals and a plurality of prompt signals corresponding to the frequency intervals. An audio processing unit 15 is configured for processing the prompt signal, and a speaker 16 is configured for converting the prompt signal into an audible sound.

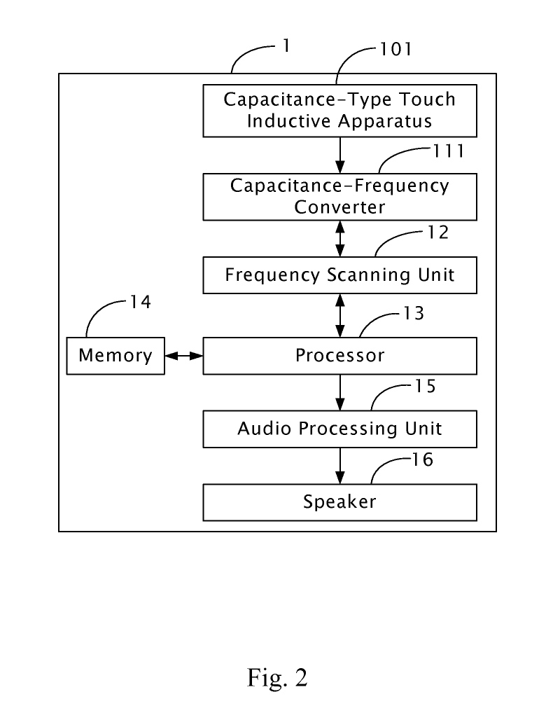

Referring to FIG. 2, in an exemplary embodiment, the touch inductive apparatus 10 is a capacitance-type touch inductive apparatus 101, and the frequency converter 11 is a capacitance-frequency converter 111. In another exemplary embodiment, the touch inductive apparatus 10 may otherwise be a resistance-type touch inductive apparatus 101, and the frequency converter 111 is a resistance-frequency converter 111. When a finger is placed on the capacitance-type inductive apparatus 101 to operate the electronic device 1, the capacitance value of the capacitance-type touch inductive apparatus 101 changes in accordance with a pressure applied on the capacitance-type touch inductive apparatus 101. The capacitance-frequency converter 111 outputs a frequency signal indicating the capacitance value.

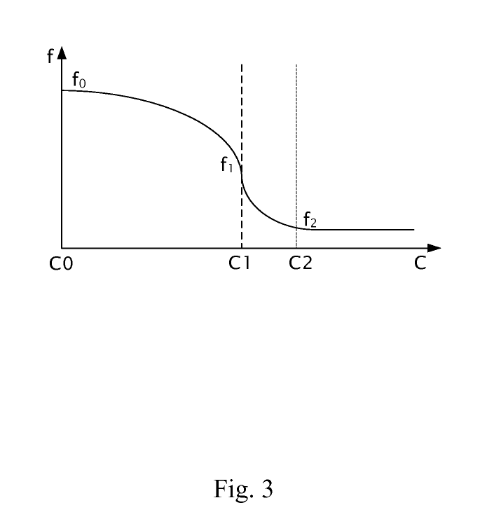

FIG. 3 is a line chart showing a capacitance-frequency curve representing a relationship between the frequency signal outputted by the capacitance-frequency converter 111 and the capacitance value of the capacitance-type touch inductive apparatus 101. The axis C represents capacitance values and the axis f represents frequency values. The capacitance value of the capacitance-type touch inductive apparatus 101 changes when the finger is placed on the capacitance-type touch inductive apparatus 101 to operate the electronic device 1. For example, when the capacitance value of the capacitance-type touch inductive apparatus 101 is changed to C0, the frequency value indicated by the frequency signal outputted by the capacitance-frequency converter 111 is f0. When the capacitance value of the capacitance-type touch inductive apparatus 101 is changed to C1, the frequency value indicated by the frequency signal outputted by the capacitance-frequency converter 111 is f1; when the capacitance value of the capacitance-type touch inductive apparatus 101 is change to C2, the frequency value of the frequency signal outputted by the capacitance-frequency converter 111 is f2. According to the capacitance-frequency curve, the capacitance values C0, C1 and C2 are increased sequentially, and the frequency values f0, f1 and f2 are decreased sequentially.

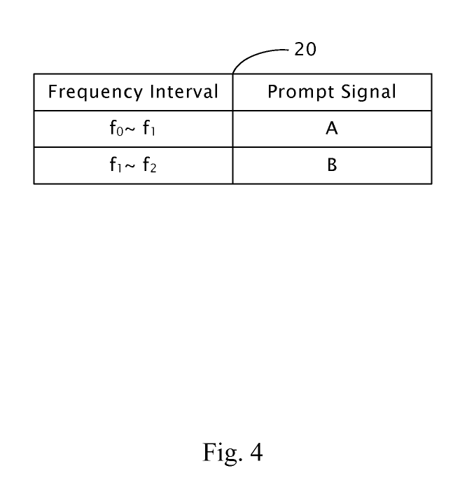

FIG. 4 shows the look-up table 20, which records a relationship between a plurality of frequency intervals and a plurality of prompt signal. In the look-up table 20, a frequency interval f0˜f1 corresponds to a prompt signal A, and a frequency interval f1˜f2 corresponds to a prompt signal B. In the exemplary embodiment, the prompt signals A and B are two different audio signals. The two audio signals are recorded in a same audio file or in two different audio files.

When a finger is placed on the capacitance-type touch inductive apparatus 101, the capacitance value of the capacitance-type touch inductive apparatus 101 changes in accordance with the pressure applied thereon. The capacitance-frequency converter 111 outputs a frequency signal corresponding to the capacitance value of the capacitance-type touch inductive apparatus 101. The scanning unit 12 scans the frequency signal and outputs a frequency value. The processor 13 receives the frequency value and looks up the look-up table 20 stored in the memory 14. The processor 13 determines a frequency interval including the frequency value, and selects a prompt signal according to the determined frequency interval. For example, if the frequency value is included in the frequency interval f0˜f1. The processor 13 selects the prompt signal A. The audio processing unit 15 processes the prompt type signal A and outputs an audible sound via the speaker 16. If the frequency is included in the frequency interval f1˜f2, the processor 13 selects the prompt signal B. The audio processing unit 15 processes the prompt signal B and output an audible sound via the speaker 16.

In another exemplary embodiment of the present invention, the memory 14 is configured for storing a predetermined frequency value which is configured for defining the frequency interval, and a predetermined prompt signal corresponding to the frequency interval. When a finger is placed on the capacitance-type touch inductive apparatus 101, the processor 13 receives a frequency value and compares the frequency value with the predetermined frequency value. If the frequency value is larger than the predetermined frequency value, the processor 13 does not output any audio signal. If the frequency value is equal to and less than the predetermined frequency value, that is, the frequency value is included in the frequency interval defined by the predetermined frequency value, the processor 13 outputs the predetermined audio signal. The audio processing unit 15 processes the predetermined audio signal, and outputs an audible sound via the speaker 16.

Based on the preferred embodiments disclosed above, an advantage of the present invention over the prior art is that the electronic device gives out a sound prompt when senses finger touching the touch inductive apparatus to simulate operation noise of mechanical keys.

Although the present invention has been specifically described on the basis of an exemplary embodiment thereof, the invention is not to be construed as being limited thereto. Various changes or modifications may be made to the embodiments without departing from the scope and spirit of the invention.

What is claimed is:

1. An electronic device with sound prompt function, comprising:
at least one touch inductive apparatus configured for sensing a finger touch thereto and accordingly changing an electrical character thereof;
a memory configured for storing at least one prompt signal corresponding to at least one predetermined frequency interval respectively;
a frequency converter configured for outputting a frequency signal in accordance with the electrical character of the at least one touch inductive apparatus;
a frequency scanning unit configured for scanning the frequency signal and outputting a frequency value accordingly;
a processor configured for selecting the corresponding prompt signal if the frequency value is included in one of the at least one predetermined frequency interval;
an audio processing unit configured for processing the prompt signal; and
a speaker configured for outputting an audible sound of the prompt signal.

2. The electronic device as claimed in claim 1, wherein the memory is further configured to store a look-up table which records a relationship of the at least one frequency interval and the at least one prompt signal corresponding to the frequency intervals.

3. The electronic device as claimed in claim 1, wherein the memory is further configured to store a predetermined frequency value which is configured for defining one of the at least one frequency interval.

4. The electronic device as claimed in claim 1, wherein the at least one touch inductive apparatus is a capacitance-type touch inductive apparatus which changes its capacitance value when sensing the finger touch, and the frequency converter is a capacitance-frequency converter.

5. The electronic device as claimed in claim 1, wherein the at least one touch inductive apparatus is a resistance-type touch inductive apparatus which changes its resistance value when sensing the finger touch, and the frequency converter is a resistance-frequency converter.

6. The electronic device as claimed in claim 2, wherein when different pressures are sequentially applied on the touch inductive apparatus, the electrical character changes to different values correspondingly, the frequency converter outputs frequency signals with different frequency values in accordance with the different electrical characters, thereby the electronic device giving out different sound prompts corresponding to the different pressures.

7. The electronic device as claimed in claim 3, wherein the processor is further configured for selecting the corresponding prompt signal by comparing the frequency value with the predetermined frequency value.
